(19) United States
(12) Patent Application Publication
(10) Pub. No.: US 2017/0164123 A1
(43) Pub. Date: Jun. 8, 2017

(54) HEARING DEVICE SYSTEM WITH A VOICE COMMUNICATION DEVICE, AND METHOD OF OPERATING THE SYSTEM

(71) Applicant: SIVANTOS PTE. LTD, Singapore (SG)

(72) Inventors: MARC AUBREVILLE, NUERNBERG (DE); ROBERT BAEUML, ECKENTAL (DE)

(21) Appl. No.: 15/373,002

(22) Filed: Dec. 8, 2016

(30) Foreign Application Priority Data
Dec. 8, 2015 (DE) 10 2015 224 643.4

(51) Int. Cl. H04R 25/00

(52) U.S. Cl. CPC H04R 25/554; H04R 25/30; H04R 2225/55

(57) ABSTRACT

A hearing device system includes a hearing device with a microphone, with a signal processing unit and with a loudspeaker connected to the signal processing unit, and a voice communication device coupled to the hearing device. A control unit which is integrated in the hearing device operates the system in different modes of operation. At least one device senses a distance between the voice communication device and the hearing device and the control unit operates the hearing device system in a first mode of operation when the distance is relatively short and in a second mode of operation when the distance is relatively greater. There is also described a method for operating the hearing device system.

### CROSS-REFERENCE TO RELATED APPLICATION

This application claims the priority, under 35 U.S.C. §119, of German patent application DE 10 2015 224 643.4, filed Dec. 8, 2015; the prior application is herewith incorporated by reference in its entirety.

### BACKGROUND OF THE INVENTION

### Field of the Invention

A hearing device is used to supply an aurally impaired person with acoustic ambient signals that are processed and particularly amplified as appropriate in order to compensate for the respective hearing impairment. To this end, a hearing device usually comprises an acoustoelectric input transducer, for example in the form of a microphone, a signal processing unit having an amplifier and an electroacoustic output transducer. The output transducer is normally implemented as a miniature loudspeaker and is also referred to as a receiver. It generates acoustic output signals that are routed to the ear of the patient and produce the desired aural perception in the patient.

There are different designs of hearing device. In the case of what are known as ITE (in the ear) hearing devices, a housing that contains all of the functional components, including the microphone and the receiver, is worn at least partially in the auditory canal. CIC (completely in canal) hearing devices are similar to ITE hearing devices, but are worn completely in the auditory canal. In the case of BTE (behind the ear) hearing devices, a housing having components such as a battery and the signal processing unit is worn behind the ear. A flexible sound tube, also referred to as the tube, routes the acoustic output signals from the receiver from the housing to the auditory canal, where an appropriate earpiece is usually provided on the sound tube for the purpose of positioning the end of the sound tube in the auditory canal. In another variant of a BTE hearing device, the receiver sits directly in an earpiece and is supplied with signals by the hearing device unit worn behind the ear via an electrical connecting cable. Such hearing devices are also referred to as RIC (receiver in canal) hearing devices.

Regardless of the configuration of the respective hearing device, hearing devices are increasingly being developed that are usable not only for their conventional function as a sound amplifier for ambient sounds but also for other purposes. As such, modern hearing devices can, by way of example, be coupled to multimedia devices such as telephones, televisions and/or music systems in order to play the audio signals thereof directly.

In this case, multimedia devices that have interfaces for Bluetooth or have radio adapters can be connected directly to the hearing devices wirelessly. For this, there are also supplementary devices, what are known as transmitters or streamers, that can be used to transmit audio signals from different signal sources to the hearing devices.

In particular, it is possible to transmit telephone conversations or music from a modern voice communication device, such as a smartphone, to a hearing device. To facilitate the conducting of a telephone conversation, the microphones of the hearing device can be switched off for an incoming telephone call, for example, in this case in order to mask out perturbing ambient sounds in the hearing device. The voice signals entering the smartphone from the other party to the conversation are transmitted to the hearing device directly and, in particular, wirelessly.

Supplementary devices for coupling in audio signals are disadvantageous because they require space and may need to be carried separately by the hearing device wearer. Manual activation of a transmission functionality is often deemed onerous. On the other hand, manual selection of settings to optimize the functionality particularly in the case of a telephone call is found to be too complicated, especially by older people, and is therefore not used.

Published patent application US 2013/0034234 A1 discloses a portable audio device for use by a hearing device wearer, and a corresponding method. The audio device comprises two sensors that are used to ascertain the distance of the audio device from a hearing device. The distance is taken as a basis for selecting between two modes of operation.

Published patent application US 2015/0334493 A1 discloses a method and a hearing aid system for improved telecommunication by means of a hearing device. To this end, the hearing device system comprises two hearing aids each having a microphone and a vibration sensor, and also a processor that receives signals that are generated by the two hearing aids and from which an output signal that is used for telecommunication is produced.

### SUMMARY OF THE INVENTION

It is accordingly an object of the invention to provide a hearing device system and method which overcomes the above-mentioned and other disadvantages of the heretofore-known devices and methods of this general type and which provides for the simple coupling of a voice communication device to a hearing device. It is a particular object to increase user comfort.

With the foregoing and other objects in view there is provided, in accordance with the invention, a hearing device system, comprising:

a hearing device having at least one microphone, a signal processing unit connected to the microphone, and a loudspeaker connected to the signal processing unit;

a voice communication device coupled to the hearing device, the voice communication device having a microphone;

at least one device for acquiring a distance signal characterizing a distance between the voice communication device and the hearing device; and

a control unit integrated in the hearing device and configured to operate the hearing device system in mutually different modes of operation, the control unit using the distance signal as a basis for operating the hearing device system in a first mode of operation in a first distance range and in a second mode of operation in a second distance range, wherein the distance between the voice communication device and the hearing device is shorter in the first distance range than in the second distance range.

In other words, the objects of the invention is achieved according to the invention by a hearing device system comprising a hearing device having at least one microphone, having a signal processing unit connected to the microphone and having a loudspeaker connected to the signal processing unit, a voice communication device that is coupled to the hearing device and that has a microphone, and a control unit for operation in different modes of operation, wherein at least one means for capturing a distance signal characterizing the distance between the voice communication device and the hearing device is comprised, wherein the control unit is integrated in the hearing device, and wherein the control unit is set up and designed to operate the hearing device system in a first mode of operation in a first distance range and in a second mode of operation in a second distance range depending on the distance signal, the distance between the voice communication device and the hearing device being shorter in the first distance range than in the second distance range.

In a first step, the invention is based on the hearing device being used as a headset for a voice communication device, e.g. for a telephone, particularly for a smartphone. In particular, the hearing device is intended to be used as a headset when a conversation needs to be conducted but the voice communication device is situated not in proximity to the hearing device but rather at some distance therefrom on the table, for example, or is carried in a trouser pocket. On the other hand, an ordinary conversation is also intended to be able to be conducted using the voice communication device in proximity to the ear or in proximity to the hearing device without needing to perform manual changeover.

In a second step, the invention recognizes that such operation of the hearing device as a headset with a remote voice communication device and during regular operation with a close voice communication device can be performed in automated fashion if the relevant modes of operation of voice communication device and hearing device, which together form the hearing device system, are chosen in automated fashion on the basis of a distance signal characterizing the distance between the hearing device that is worn and the voice communication device. To this end, means for capturing the relevant distance signal are provided. In this case, the control unit takes a, in particular currently ascertained, value of the distance signal as a basis for automatically operating the hearing device system in a first mode of operation in a first distance range and in a second mode of operation in a second distance range, the distance between the voice communication device and the hearing device being shorter in the first distance range than in the second distance range. In other words, in the case of the hearing device that is worn, the first mode of operation is automatically chosen for a voice communication device in proximity to the head of the hearing device wearer and the second mode of operation is automatically chosen for a voice communication device remote from the head.

The distance signal is preferably used as such immediately to choose the first or the second mode of operation. By way of example, a signal strength, a signal shape and/or a signal frequency of the distance signal is/are used to infer the proximity of the voice communication means to the hearing device, and accordingly to choose the first mode of operation. In another advantageous variant, a further signal, which may be particularly the distance between the hearing device and the voice communication device itself, is derived from the distance signal, and the first or the second mode of operation is chosen on the basis of the derived signal or the distance as such. By way of example, a derived signal is a signal that is proportional to the distance and in another univocal relationship. Alternatively, the derived signal may be a degree of correlation to a known or similar other signal that indicates the proximity or remoteness of the voice communication device from the hearing device. Naturally, the distance signal transmitted by the means that is used may also, as such, already be the distance.

A distance chosen for selecting the first distance range is preferably between 0 cm and 20 cm. The distance for the second distance range is preferably chosen to be greater than 20 cm. The ranges for the distance signal or for values of the distance signal or for the signals or values derived therefrom can be chosen accordingly.

Changing the modes of operation does not require the hearing device wearer him or herself to take action. The parameters, settings and active or inactive components of the modes of operation preferably match those of the functionality of the hearing device and the voice communication device that is desired in the first and in the second mode of operation.

In an advantageous variant embodiment, in the first mode of operation, the hearing device is operated to receive a piece of voice information from the voice communication device that is in proximity, with the hearing device wearer simultaneously speaking into the voice communication device held to his ear in the usual way. In the second mode of operation, that is to say when the voice communication device is remote, the hearing device is operated, in another preferred configuration, with a headset functionality. For automated operation in this regard, the control unit is advantageously set up and designed to switch the microphone of the voice communication device to an active operating state in the first mode of operation and to an inactive operating state in the second mode of operation. An active operating state of the microphone describes that state in which the microphone is switched on and processes received acoustic signals, particularly converts them into electrical signals. An inactive operating state describes that state in which the microphone is not used for the respective communication, that is to say that its output signal is not processed further or not forwarded or masked out, for example. In particular, a microphone that is technically switched off is also an inactive microphone. In this context, the term inactive operating state covers disconnection both in terms of signals and in terms of power supply. Hence, the hearing device wearer speaks directly into the active microphone of the close voice communication device, while remotely the microphone of the voice communication device is inactive. Voice information is then transmitted from the hearing device to the voice communication device expediently via an appropriate nonacoustic coupling.

The microphone(s) of the hearing device is/are preferably active in both modes of operation. Particularly in a headset mode, this makes it possible to ensure that ambient sounds are still sensed and discerned by the hearing device wearer. This is necessary particularly in situations in which the hearing device wearer is a road user, for example. In a variant, however, the control unit is set up to switch off the microphones of the hearing device in the first mode of operation.

Preferably, the voice communication device comprises a loudspeaker, wherein the control unit is set up and designed to operate the loudspeaker of the voice communication device actively in the first mode of operation, so that output signals from the loudspeaker of the voice communication device are received acoustically by the microphone of the hearing device. Accordingly, in this variant, the conversation of the party to the conversation is transmitted to the microphone of the hearing device via the loudspeaker of the voice communication device.

In accordance with a further preferred feature of the invention, the control unit is configured to couple the hearing device and the voice communication device by radio or by wire in the second mode of operation for the purpose of transmitting voice information. This is the case when the voice communication device is remote. Hence, the hearing device operates as a headset in the second mode of operation. For a telephone call, the complete voice information is interchanged or transmitted between the voice communication device and the hearing device entirely via a radio link or electronically. The microphone of the voice communication device is inactive in this second mode of operation. The loudspeaker of the voice communication device is preferably switched off in the second mode of operation. In this mode, the voice communication device is preferably operated such that the input signals received via its own microphone for further processing and supplying to the respective telecommunication network are replaced by the signals received from the hearing device.

In order to ascertain the distance signal characterizing the respective current distance between the hearing device and the voice communication device, at least one device that is suitable for this purpose is provided. Preferably, an RF (radio frequency) sensor element is comprised as a device for capturing a signal that characterizes the distance between the voice communication device and the hearing device. Such a sensor element is typically part of an electronic component used for the radio transmission of signals in a hearing device and, by way of example, is in the form of a means for capturing the signal strength (received signal strength indicator, RSSI) of a radio signal transmitted by the voice communication device. On the basis of the detected signal strength, it is possible to infer the distance between the hearing device and the voice communication device. As such, in the case of a strong signal, it can be assumed that the voice communication device is arranged in proximity to the hearing device. The appropriately designed control unit of the hearing device system is then accordingly used to take the possibly scaled signal strength as a basis for switching to the first mode of operation or to the second mode of operation.

In an additional or alternative variant, an induction coil is provided as a device for acquiring the distance signal that characterizes the distance between the voice communication device and the hearing device. By way of example, the induction coil is usually integrated in the hearing device as a telephone coil and allows particularly an inductive coupling to a conventional telephone receiver. This so-called telephone coil also allows the proximity of a voice communication device to be inferred, wherein a first variant involves the strength of the magnetic field produced by the voice communication device, as measured using the telephone coil, being detected. In particular, the discerned magnetic field is used to detect the presence of the voice communication device in proximity to the hearing device, and the control unit is used to automatically switch to the first mode of operation. When the magnetic field disappears, the hearing device system is expediently operated in the second mode of operation. In a second variant, a correlation function ascertains the similarity (degree of correlation) of the signal captured via the telephone coil with a signal captured via an RF antenna of the hearing device, for example. From the degree of correlation, the proximity of the voice communication device to the hearing device is then inferred. The degree of correlation is taken as a basis for operating the hearing device system in the first (high degree of correlation) or in the second (low degree of correlation) mode of operation.

In an additionally advantageous configuration, a proximity sensor is provided as a device for determining the distance between the voice communication device and the hearing device. The proximity sensor is preferably a component of the voice communication device. Preferred configurations of the proximity sensor comprise capacitive sensors.

The control unit used may be the control unit of the voice communication device or that of the hearing device. It is also possible to use a separate control unit outside the two devices. According to the invention, the control unit is integrated in the hearing device.

Preferably, the decision about the choice of the mode of operation is made in the hearing device or in the control unit of the hearing device. The mode of operation to be chosen or the settings associated therewith are transmitted from the control unit, for example via a radio link that has been set up, to the voice communication device, which alters its settings as appropriate and coordinates them with the hearing device.

With the above and other objects in view there is also provided, in accordance with the invention, a method for operating a hearing device system. The hearing device system includes a hearing device having at least one microphone, having a signal processing unit connected to the microphone and having a loudspeaker connected to the signal processing unit. The hearing device system further includes a voice communication device that is coupled to the hearing device and that has a microphone. A control unit that operates the hearing device system in different modes of operation, wherein the control unit of the hearing device is used for operating the hearing device system, wherein the control unit uses at least one device for capturing a distance signal characterizing the distance between the voice communication device and the hearing device to operate the hearing device system in a first mode of operation in a first distance range and in a second mode of operation in a second distance range, and wherein the distance between the voice communication device and the hearing device is shorter in the first distance range than in the second distance range.

Other features which are considered as characteristic for the invention are set forth in the appended claims.

Although the invention is illustrated and described herein as embodied in a hearing device system having a voice communication device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a hearing device system with a voice communication device positioned in proximity to the hearing device;

FIG. 2 shows the hearing device system according to FIG. 1 with a voice communication device at a remote distance from the hearing device; and

FIG. 3 shows a schematic representation of the hearing device system according to FIGS. 1 and 2.

### DETAILED DESCRIPTION OF THE INVENTION

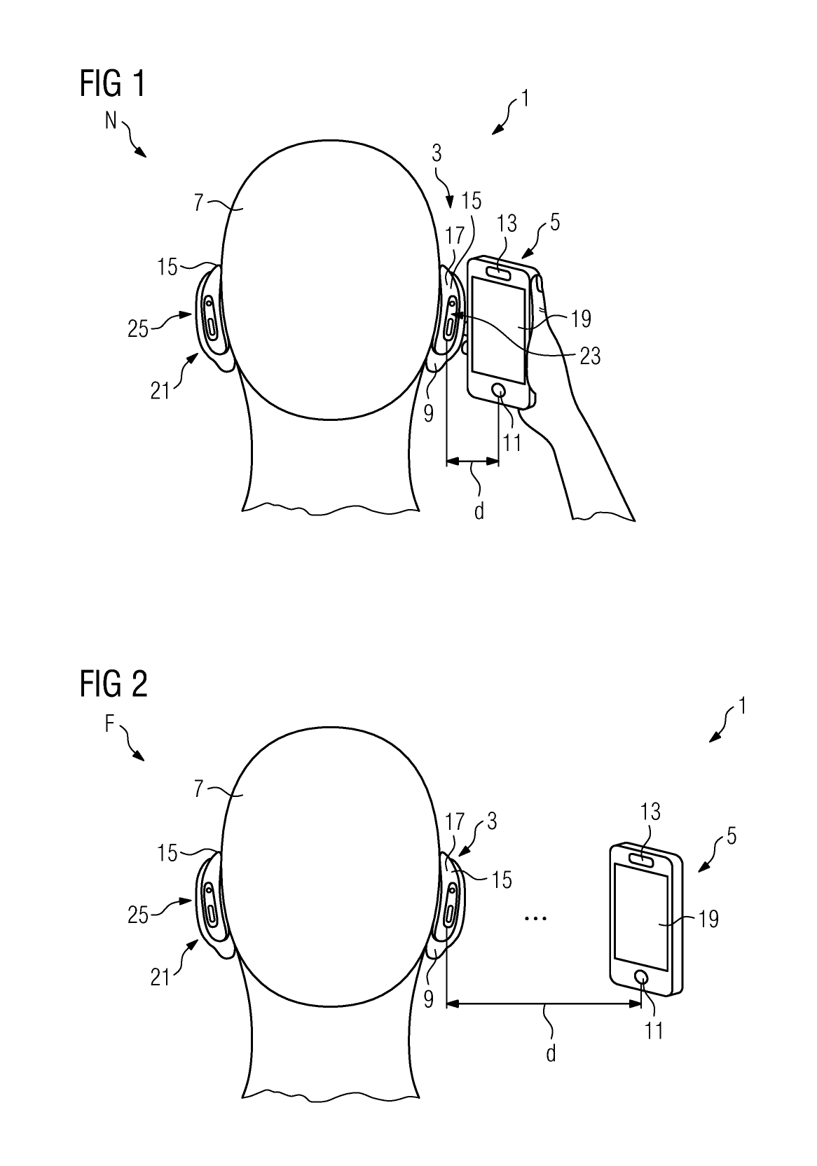

Referring now to the figures of the drawing in detail and first, particularly, to FIG. 1 thereof, there is shown a hearing device system 1 with a hearing device 3 and with a voice communication device 5. In the present case, the voice communication device 5 is in the form of a smartphone. The hearing device wearer 7 holds the smartphone 5 to his ear 9 in order to conduct a telephone conversation. In the state represented, in which the voice communication device 5 is in direct proximity to the hearing device 3, the hearing device system 1 is automatically operated in a first operating mode N. In this case, the microphone 11 of the smartphone 5 is switched on and picks up the voice signal spoken by the hearing device wearer 7 directly. In the first operating mode N, the voice signal from the party to the conversation can be captured via the active loudspeaker 13 of the voice communication device 5 via the microphone 15 of the hearing device 3 and processed further. Alternatively, in the first mode of operation N, incoming voice information from the voice information device 5 is transmitted to the hearing device 3 by radio or inductively.

The first mode of operation N corresponding to the constellation according to FIG. 1 is chosen by means of an appropriate control unit 17, which in the present case is integrated in the hearing device 3. The control unit 17 is used to evaluate a distance signal characterizing a distance d between the hearing device 3 and the voice communication device 5. The distance signal d is taken as a basis for choosing the relevant mode of operation. Changeover or setting take place automatically in this case. The hearing device wearer 7 himself does not need to take action.

The respective current distance between the hearing device 3 and the voice communication device 5, on the basis of which the control unit 17 sets the respective mode of operation, is checked using means 19 for capturing a distance signal characterizing the distance d. By way of example, a proximity sensor of the voice communication device 3 is used as such a means 19. This is particularly a photo resistor of a smartphone, which measures the brightness of the ambient light. When the voice communication device 5 is brought to the ear 9, the decreasing distance from the hearing device 3 means that the intensity of the ambient light measured by the photo resistor is reduced. This reduction is discerned by means of the proximity sensor 19. From this sensed reduction, the control unit 17 infers the proximity of the voice communication device 5 for the hearing device 3 and switches to the first mode of operation N.

Naturally, as an alternative to the aforementioned proximity sensor 19, it is possible to use other or additional means for discerning the current distance between the hearing device 3 and the voice communication device 5. By way of example, this is accomplished by using a radio chip on the hearing device 3 to measure the field strength of a radio signal emanating from the voice communication device 5. On the basis of the field strength, the control unit 17 switches to the relevant mode of operation, for example to the first mode of operation N when the field strength is high.

In FIG. 2, the smartphone 5 is at a distance from the hearing device 3. To set up a telephone call, the hearing device 3 is intended to be operated as a headset. To this end, the control unit 17, which discernes the longer distance d between the voice communication device 5 and the hearing device 3, automatically switches the hearing device system 1 to a second operating mode F. In this operating mode F, the microphone 11 of the voice communication device 5 is switched to inactive for the telephone call. The communication, that is to say the transmission of a piece of voice information between the voice communication device 5 and the hearing device 3, is effected via a radio link, for example according to a Bluetooth standard, in the second mode of operation F.

The spoken voice of the hearing device wearer 7 is picked up via the microphone 15 of the hearing device 3 and converted into an electrical information signal. The electrical signal is transmitted to the voice communication device 5 wirelessly via an appropriate antenna 25 of the hearing device 3. The voice signal from the party to the conversation is also transmitted from the voice communication device 5 to the hearing device 3 by radio, is processed in the signal processing unit 21 in said hearing device and is output via the loudspeaker 23 of the hearing device 3.

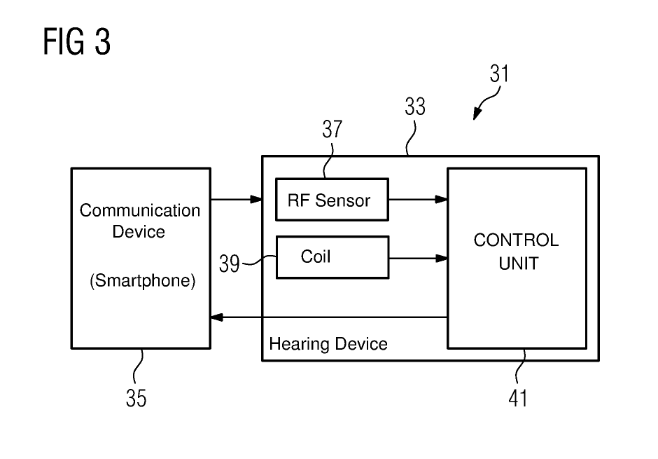

FIG. 3 shows a schematic representation of a further hearing device system 31. The hearing device system 31 comprises a hearing device 33 and a voice communication device 35 in the form of a smartphone. In the present case, an RF (radiofrequency) sensor element 37 and a telephone coil 39 are shown as means for discerning a distance signal characterizing the distance between the hearing device 33 and the voice communication device 35. Both the signal strength of the radio signal detected by the sensor element 37 and sensing of a magnetic field of the voice communication device 5 via the telephone coil 39 of the hearing device 33 can be used to infer a distance between the hearing device 33 and the voice communication device 35. In a variant, the degree of correlation between the signal received from the telephone coil 39 and the signal received from the RF sensor element is determined. For a high degree of correlation, the control unit 41 operates the hearing device system 35 in the first mode of operation N; for a low degree of correlation, in the second mode of operation F.

The control unit 41, which is integrated in the hearing device 33 in the present case, is used to take the respective distance signal between the hearing device 33 and the voice communication device 5 as a basis for setting the respective mode of operation N or F or changing over between the two modes of operation N, F.

The following is a summary list of reference numerals and the corresponding structure used in the above description of the invention:

1 hearing device system

3 hearing device

5 voice communication device

7 hearing device wearer

9 ear

11 microphone of the voice communication device

13 loudspeaker of the voice communication device

15 microphone of the hearing device

17 control unit

19 means for discerning a distance signal

21 signal processing unit

23 loudspeaker of the hearing device

25 antenna

31 hearing device system

33 hearing device

35 voice communication device

37 RF sensor element

39 telephone coil

41 control unit

N first mode of operation

F second mode of operation

d distance

1. A hearing device system, comprising:
a hearing device having at least one microphone, a signal processing unit connected to said microphone, and a loudspeaker connected to said signal processing unit;
a voice communication device coupled to said hearing device, said voice communication device having a microphone;
at least one device for acquiring a distance signal characterizing a distance between said voice communication device and said hearing device; and
a control unit integrated in said hearing device and configured to operate the hearing device system in mutually different modes of operation, said control unit using the distance signal as a basis for operating the hearing device system in a first mode of operation in a first distance range and in a second mode of operation in a second distance range, wherein the distance between said voice communication device and said hearing device is shorter in the first distance range than in the second distance range.

2. The hearing device system according to claim 1, wherein said control unit is configured to switch the microphone of said voice communication device to an active operating state in the first mode of operation and to an inactive operating state in the second mode of operation.

3. The hearing device system according to claim 1, wherein said voice communication device comprises a loudspeaker and said control unit is configured to operate said loudspeaker of said voice communication device actively in the first mode of operation, so that output signals from the loudspeaker of said voice communication device are received acoustically by said microphone of said hearing device.

4. The hearing device system according to claim 1, wherein said control unit is configured to couple said hearing device and said voice communication device by radio or by wire in the second mode of operation for the purpose of transmitting voice information.

5. The hearing device system according to claim 1, wherein said at least one device for acquiring the distance signal includes an RF sensor element disposed to sense the distance between said voice communication device and said hearing device.

6. The hearing device system according to claim 1, wherein said at least one device for acquiring the distance signal includes an induction coil disposed to sense the distance between said voice communication device and said hearing device.

7. The hearing device system according to claim 1, wherein said at least one device for acquiring the distance signal includes a proximity sensor disposed to sense the distance between said voice communication device and said hearing device.

8. A method for operating a hearing device system, the hearing device system including:
a hearing device with at least one microphone, a signal processing unit connected to the microphone, a loudspeaker connected to the signal processing unit, and a control unit configured to operate the hearing device system in different modes of operation; and
a voice communication device to be coupled to the hearing device; and
the method comprising:
determining with the control unit of the hearing device a distance between the hearing device and the voice communication device by acquiring a distance signal characterizing the distance between the voice communication device and the hearing device; and
operating the hearing device system in a first mode of operation in a first distance range and in a second mode of operation in a second distance range, wherein the distance between the voice communication device and the hearing device is shorter in the first distance range than in the second distance range.

9. The method according to claim 8, which comprises with the control unit switching a microphone of the voice communication device to an active operating state in the first mode of operation and to an inactive operating state in the second mode of operation.

10. The method according to claim 8, which comprises with the control unit operating a loudspeaker of the voice communication device actively in the first mode of operation, so that output signals from the loudspeaker of the voice communication device are received acoustically by the microphone of the hearing device.

11. The method according to claim 8, which comprises with the control unit coupling the hearing device and the voice communication device to one another by radio or by wire in the second mode of operation for the purpose of transmitting voice information.

12. The method according to claim 8, which comprises sensing the distance between the voice communication device and the hearing device with an RF sensor element.

13. The method according to claim 8, which comprises sensing the distance between the voice communication device and the hearing device with an induction coil.

14. The method according to claim 8, which comprises sensing the distance between the voice communication device and the hearing device with a proximity sensor.
